(19) United States
(12) Patent Application Publication
(10) Pub. No.: US 2012/0285243 A1
(43) Pub. Date: Nov. 15, 2012

(54) ROTATION MEASURING DEVICE

(75) Inventor: Hirotaka Yamamoto, Kitakyushu-shi (JP)

(73) Assignee: MATSUSHIMA MACHINERY LABORATORY CO., LTD., Kitakyushu-shi (JP)

(21) Appl. No.: 13/194,683

(22) Filed: Jul. 29, 2011

(30) Foreign Application Priority Data
May 9, 2011 (JP) 2011-104439

(51) Int. Cl. G01P 3/00

(52) U.S. Cl. 73/488

(57) ABSTRACT

A rotation measuring device 10 including a proximity switch 14 detecting rotational speed of an object to be measured, a controller 11 receiving pulse signals from the switch 14, and a display 34 connected to the controller 11, the controller 11 including a rotational speed calculation means, the device 10 calculating the rotational speed based on the pulse signals by the rotational speed calculation means and indicating the rotational speed on the display 34, the controller 11 including: a standard rotational speed setting means for setting a measured rotational speed as a standard rotational speed by button operation; an upper and lower limits setting means for setting maximum and minimum rotational speeds based on the standard rotational speed; and a warning signal generating means generating warning signal outputs when the rotational speed is over the maximum rotational speed or below the minimum rotational speed.

### TECHNICAL FIELD

The present invention relates to a device for measuring a rotational speed (number of revolutions) of a rotating object by a proximity sensor and sending warning signals when detecting abnormal rotational speeds.

### BACKGROUND ART

Patent Literature 1 discloses a rotation detecting device for detecting a detection portion integrally formed with a rotating member (e.g., rotating shaft) by a proximity sensor etc., thereby measuring a rotational speed of the rotating member. The rotation detecting device has first and second displays to indicate the rotational speed and abnormal rotations of the rotating shaft, respectively.

### CITATION LIST

### Patent Literature

[Patent Literature 1] Japanese Unexamined Patent Application Publication No. 10-246732

### SUMMARY OF INVENTION

### Technical Problem

Patent Literature 1 discloses the rotation detecting device for working tools (e.g., drills) for which standard rotational speeds and abnormal rotational speeds are known in advance. In other words, the device of Patent Literature 1 is not universally used. Particularly, different objects have different normal rotational speeds and different abnormal rotational speeds, but the device of Patent Literature 1 cannot easily change the settings of the standard and abnormal rotational speeds in accordance with the objects.

The present invention has been made in view of the above circumstances and has an object to provide a rotation measuring device for detecting a rotational speed of an object to be measured (hereinafter also referred to as “object”), setting upper and lower limits of a standard rotational speed based on the detected rotational speed, and outputting a warning signal when detecting that the rotational speed of the object gets out of the range of the standard rotational speed.

### Solution to Problem

To accomplish the above object, the present invention provides a rotation measuring device including a proximity switch detecting rotational speed of an object to be measured, a controller receiving pulse signals from the proximity switch, and a display connected to the controller, the controller including a rotational speed calculation means, the rotation measuring device calculating the rotational speed of the object based on the pulse signals by the rotational speed calculation means and indicating the rotational speed of the object on the display, the controller comprising: a standard rotational speed setting means setting a measured rotational speed as a standard rotational speed by button operation; an upper and lower limits setting means setting a maximum rotational speed and a minimum rotational speed based on the standard rotational speed; and a warning signal generating means generating warning signal outputs when the rotational speed of the object is over the maximum rotational speed or below the minimum rotational speed.

In the rotation measuring device according to the present invention, it is preferable that the controller includes a start timer disabling the rotational speed calculation means after a power is turned on.

### Advantageous Effects of Invention

The rotation measuring device according to the present invention stores the standard rotational speed according to the actually measured rotational speed, sets the maximum and minimum rotational speeds within an appropriate range based on the standard rotational speed, and then determines the abnormal rotational speeds. Thus, the rotation measuring device can easily set the standard rotational speed of the object regardless of whether it rotates at high speed or low speed, thereby detecting the abnormal rotation of the actual object.

When detecting the abnormal rotation of the object, the rotation measuring device outputs the warning signal, which is useful to take a subsequent measure.

If the rotation measuring device according to the present invention has the start timer which disables the rotational speed calculation means after the power is turned on, the rotation of the object can be monitored more precisely. The start timer enables precise monitoring because it prevents the rotation measuring device from measuring the object in transient state, i.e., from the start up to the normal rotation until the rotation measuring device arrives at its normal state of operation.

### BRIEF DESCRIPTION OF DRAWINGS

FIG. 1(A) and FIG. 1(B) are explanatory views of a rotation measuring device according to one embodiment of the present invention.

FIG. 2 is an internal configuration diagram of the rotation measuring device.

FIG. 3(A) and FIG. 3(B) are partial circuit diagrams of the rotation measuring device.

FIG. 4 is an operational flow diagram of the rotation measuring device.

### DESCRIPTION OF EMBODIMENTS

Referring to the accompanying drawings, embodiments of the present invention will be explained.

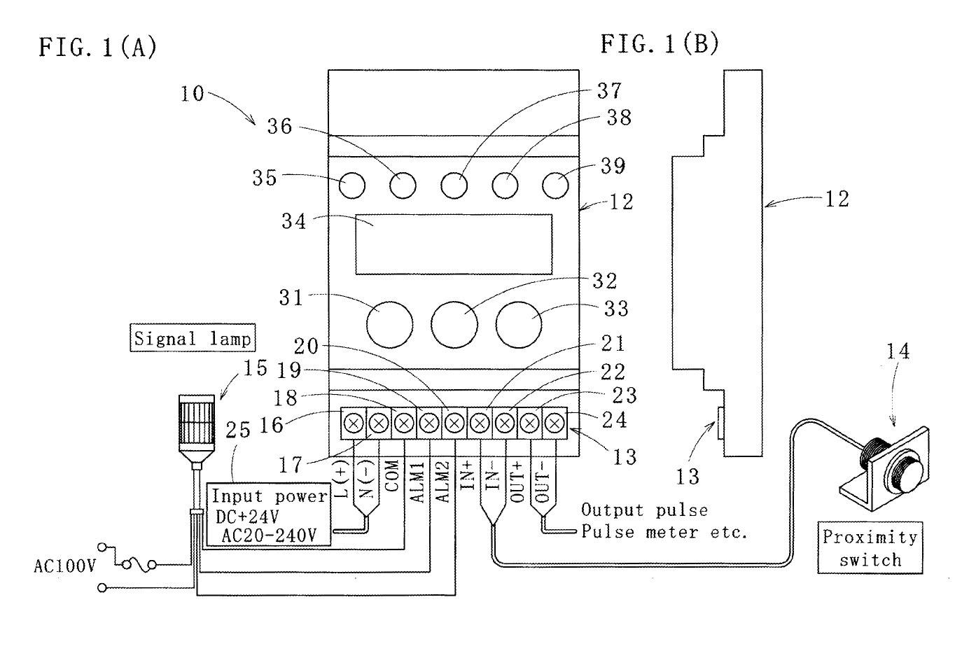

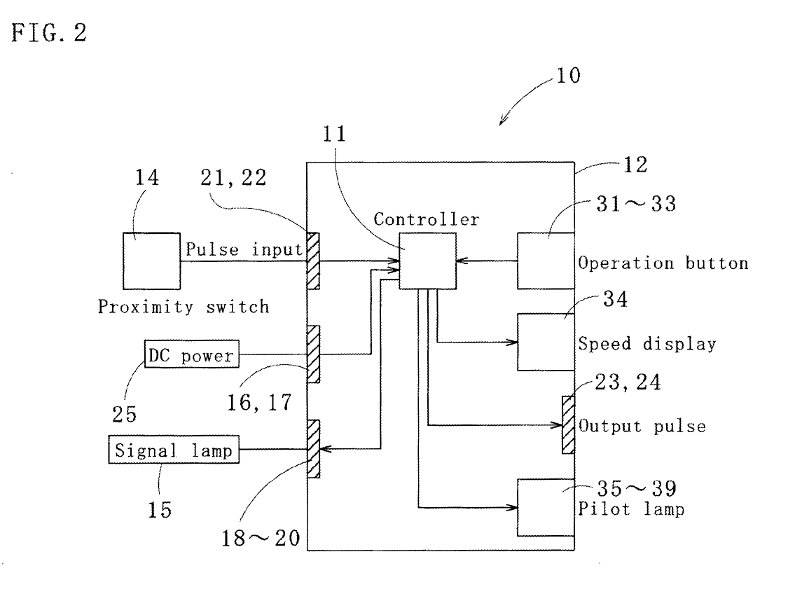

As shown in FIGS. 1(A), 1(B), and 2, a rotation measuring device 10 according to one embodiment of the present invention includes a controller 11 having a microcomputer therein, a body 12 made of a plastic outer case, a terminal block 13 exposed on the body 12, a proximity switch (proximity sensor) 14 connected to the body 12 via the terminal block 13, and a signal lamp 15 connected to the terminal block 13.

Provided at the lower part of the body 12 are terminals 16 to 24, which are included in the terminal block 13. The terminals 16 and 17 are power supply terminals to be connected to a 24V DC power supply (e.g., an adapter) 25. As an alternative, an AC power supply may be used. The terminals 18 to 20 are terminals for outputting the warning signals. The terminal 18 is a common terminal (COM) to provide contact outputs to the signal lamp 15 when the abnormal rotational speeds are detected. The signal lamp 15 employs a commercial power supply of 100V. When a measured rotational speed N exceeds a maximum rotational speed Nu, the terminals 18 and 19 are closed and the signal lamp 15 lights up in, for example, orange. When the measured rotational speed N falls below a preset minimum rotational speed Nd, the terminals 18 and 20 are closed and the signal lamp 15 lights up in red.

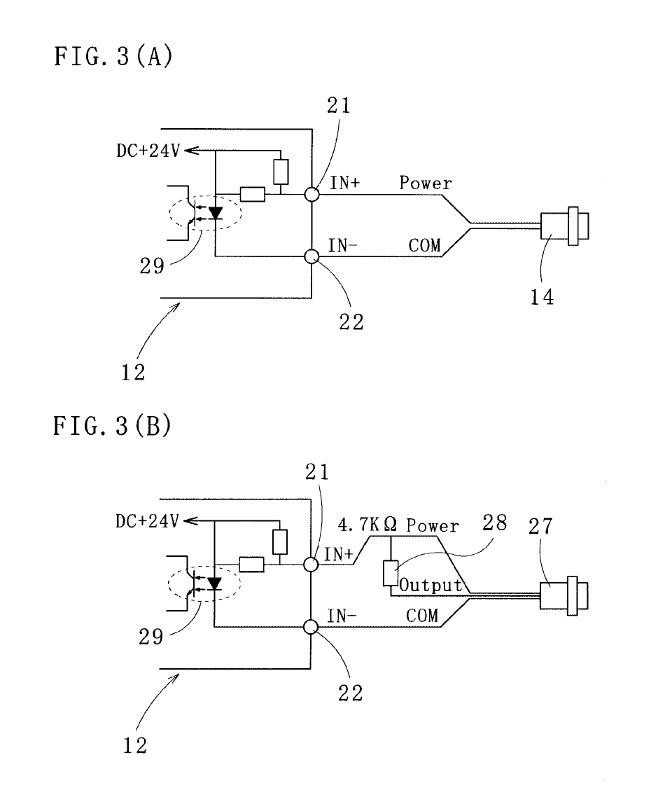

The terminals 21 and 22 are connected to the proximity switch 14. FIG. 3(A) shows the terminals 21 and 22 applied to the two-wire proximity switch 14. When a three-wire proximity switch 27 is used, as shown in FIG. 3(B), a resistance 28 of 4.7-kΩ is connected to the power supply and the output, and the switch 27 is connected to the terminals 21 and 22. Pulse signals from the proximity switch 14 or 27 are input to the controller 11 via a photocoupler 29.

The proximity switch 14 (27) outputs detection signals to the terminals 23 and 24 in opencollector mode (i.e., non-contact output).

The controller 11 is coupled with operation buttons 31 to 33 and a display 34. The controller 11 is also connected with pilot lamps 35 to 39 of light emitting diodes (LEDs). The pilot lamp 35 is a power pilot lamp, which lights up when the power is turned on. The pilot lamp 36 lights up when the inputs from the proximity switch 14 (27) are detected. The pilot lamps 37 and 38 light up when an abnormal rotational speed is detected (i.e., when the rotational speed gets out of the range of the standard rotational speed). The pilot lamps 37 and 38 remain on while the abnormal rotational speed is detected, but flash on and off if the rotational speed returns to normal (the abnormal rotational speed is cleared) without a reset operation. The pilot lamp 39 lights up in accordance with output pulses sent from the terminals 23 and 24.

The display 34 is a digital display, which counts the pulse signals measured by the proximity switch 14 and displays the counted signals as the rotational speed (unit: rpm). The proximity switch 14 detects a metal projected part of the object or a metal projection attached to the object, thereby providing on-off signals.

The controller 11 has (a) rotational speed calculation means for calculating a rotational speed based on pulse signals from the proximity switch 14, (b) standard rotational speed setting means for setting a rotational speed measured by holding down the operation button 33 for five seconds or more as a standard rotational speed, (c) upper and lower limits setting means for setting a maximum rotational speed and a minimum rotational speed based on the standard rotational speed, and (d) warning signal generating means for generating warning signals when the rotational speed of the object exceeds the maximum rotational speed or falls below the minimum rotational speed.

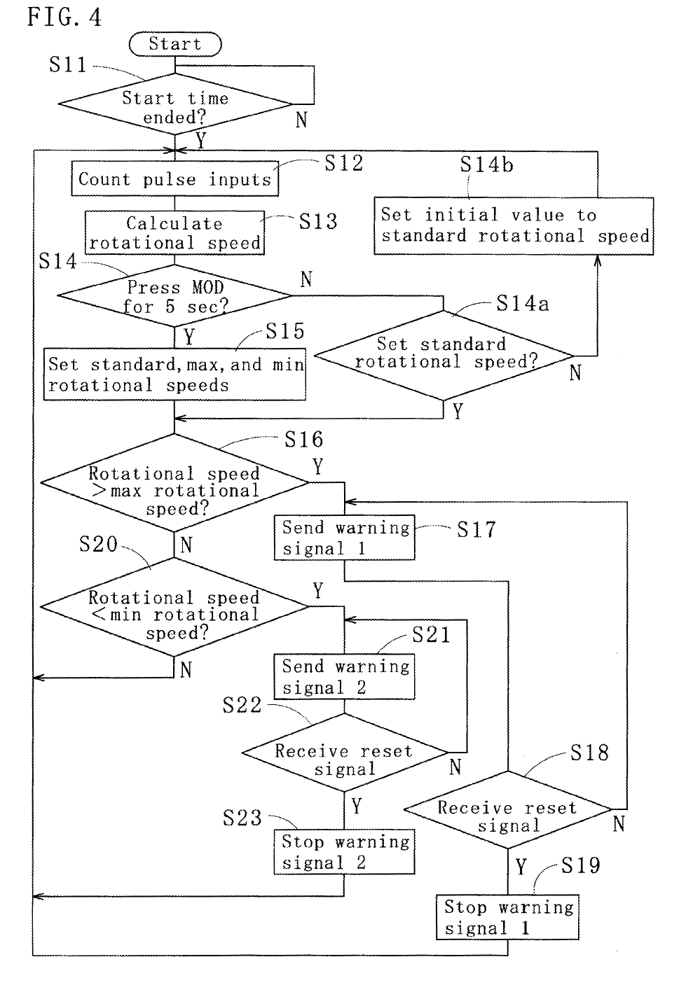

Referring to FIG. 4, descriptions will be given on programs stored in the microcomputer, which is built in the controller 11.

By turning on the power of the rotation measuring device 10, a start timer is activated to count a preset start time (e.g., 10 seconds) (Step S11). After the counting of the start time, the rotation measuring device 10 counts the number of pulses sent from the proximity switch 14 (Step S12), and calculates the rotational speed (rpm) of the object (Step S13). Until the start timer completes the counting, the rotational speed calculation means is in the inactive condition.

When the operation button 33 is held down for five seconds or more, the average rotational speed detected measured during the period is stored as the standard rotational speed Ns. Based on the rotational speed N (the standard rotational speed Ns) of the object being measured, the maximum rotational speed Nu and the minimum rotational speed Nd are set using preset values (e.g., Nu=Ns×1.05 and Nd=Ns×0.9), respectively (Step S15). The values (1.05 and 0.9) for setting the maximum and minimum rotational speeds can be changed if needed.

If the operation button 33 is held down for less than five seconds or is not pressed at all in Step S14, the setting of the standard rotational speed Ns is checked (Step S14a). If the standard rotational speed Ns is already set, Step S16 is taken. If the standard rotational speed Ns is not set, preset initial values are set as the maximum and minimum standard rotational speeds (Step S14b), and then Step S12 is taken again to count the number of pulse signals to calculate the rotational speed.

Next, the rotational speed N of the object is measured. If the rotational speed N exceeds the maximum rotational speed Nu (Step S16), a warning signal 1 (one example of the warning signal outputs) is sent. Specifically, a closed contact signal is sent to the terminals 18 and 19 (Step S17). This closed contact signal can be easily sent with a relay connected to the controller 11. The closed contact signal stops when a reset signal is sent by operating one or both of the operation buttons 31 and 32 (Steps S18 and S19).

If the rotational speed N falls below the minimum rotational speed Nd (Step S20), a warning signal 2 (one example of the warning signal outputs) is sent (Step S21). In this case, the terminals 18 and 20 are closed contacts. The warning signal 2 stops when the reset signal is sent by operating one or both of the operation buttons 31 and 32 (Steps S22 and S23).

After the reset operation is completed, Step S12 is taken again to display the normal rotational speed on the display 34. As previously explained, the pilot lamps 37 and 38 light up when the abnormal rotational speeds are detected.

Alternatively, both of the warning signals 1 and 2 can be outputted simultaneously in any of the following cases: (a) if the rotational speed N exceeds the maximum rotational speed Nu, or (b) if the rotational speed N falls below the minimum rotational speed Nd. Here, the circuits of the warning signals 1 and 2 are independent of each other.

The present invention is not limited to the above-stated embodiments, but includes modifications of circuit configurations, the upper and lower limits, and display methods, etc., without departing from the spirit and scope of the present invention.

### INDUSTRIAL APPLICABILITY

In the rotation measuring device according to the present invention, the proximity switch is placed near the object to be measured, i.e., a rotating machinery, in order to measure the rotational speed of the object. Further, the rotational speed of the object being measured can be set as the standard rotational speed by button operation. Based on the standard rotational speed, the maximum and minimum rotational speeds are set. Thus, the operation of the rotation measuring device is quite easy. What is more, the rotation measuring device can be easily attached to conventional rotating machineries, and unusual conditions of the rotating machineries can be detected with ease.

Furthermore, the device includes the warning signal generating means for generating the warning signals when the abnormal rotational speeds are detected, thereby allowing a security alarm to be activated and the warning signals to be sent to a PC etc.

### REFERENCE SIGNS LIST

10: rotation measuring device, 11: controller, 12: body, 13: terminal block, 14: proximity switch, 15: signal lamp, 16-24: terminal, 25: DC power supply, 27: proximity switch, 28: resistance, 29: photocoupler, 31-33: operation button, 34: display, 35-39: pilot lamp

1. A rotation measuring device including a proximity switch detecting rotational speed of an object to be measured, a controller receiving pulse signals from the proximity switch, and a display connected to the controller, the controller including a rotational speed calculation means, the rotation measuring device calculating the rotational speed of the object based on the pulse signals by the rotational speed calculation means and indicating the rotational speed of the object on the display, the controller comprising:
a standard rotational speed setting means setting a measured rotational speed as a standard rotational speed by button operation;
an upper and lower limits setting means setting a maximum rotational speed and a minimum rotational speed based on the standard rotational speed; and
a warning signal generating means generating warning signal outputs when the rotational speed of the object is over the maximum rotational speed or below the minimum rotational speed.

2. The rotation measuring device as defined in claim 1, wherein the controller includes a start timer disabling the rotational speed calculation means after a power is turned on.

3. The rotation measuring device as defined in claim 2, wherein the warning signal outputs include a contact output and a non-contact output.
